(19) United States
(12) Patent Application Publication
(10) Pub. No.: US 2013/0325941 A1
(43) Pub. Date: Dec. 5, 2013

(54) ROUTING DECISION CONTEXT OBJECTS

(71) Applicants: Robert A. Mann, Carp (CA); Peter K. Jorgensen, Nepean (CA); Darryl Jaakkola, Carp (CA)

(72) Inventors: Robert A. Mann, Carp (CA); Peter K. Jorgensen, Nepean (CA); Darryl Jaakkola, Carp (CA)

(73) Assignee: Alcatel-Lucent Canada, Inc., Ottawa (CA)

(21) Appl. No.: 13/482,690

(22) Filed: May 29, 2012

(51) Int. Cl. G06F 15/16

(52) U.S. Cl. 709/204

(57) ABSTRACT

Various exemplary embodiments relate to a method and related network node including one or more of the following: receiving a first Diameter message at the DRA from a first origin device; determining a first message type associated with the first Diameter message; identifying a first set of rules of a plurality of sets of rules as being associated with the first message type; evaluating a first rule of the first set of rules; and transmitting a message based on the evaluation of the first rule.

### CROSS-REFERENCE TO RELATED APPLICATIONS

This application is related to the following co-pending application, which is incorporated herein by reference: application Ser. No. [To Be Determined], Attorney Docket Number ALC 3810, “ROUTING DECISION CONTEXT OBJECTS.”

### TECHNICAL FIELD

Various exemplary embodiments disclosed herein relate generally to computer networking.

### BACKGROUND

Since its proposal in Internet Engineering Task Force (IETF) Request for Comments (RFC) 3588, the Diameter protocol has been increasingly adopted by numerous networked applications. For example, the Third Generation Partnership Project (3GPP) has adopted Diameter for various policy and charging control (PCC), mobility management, and IP multimedia subsystem (IMS) applications, As IP-based networks replace circuit-switched networks, Diameter is even replacing SS7 as the key communications signaling protocol. As networks evolve, Diameter is becoming a widely used protocol among wireless and wireline communications networks.

One significant aspect of the Diameter protocol is Diameter packet routing. Entities referred to as Diameter routing agents (DRAs) facilitate movement of packets in a network. In various deployments, DRAs may perform elementary functions such as simple routing, proxying, and redirect.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a Diameter Routing Agent (DRA) for processing a Diameter message, the method including one or more of the following: receiving a first Diameter message at the DRA from a first origin device; determining a first message type associated with the first Diameter message; identifying a first set of rules of a plurality of sets of rules as being associated with the first message type; evaluating a first rule of the first set of rules; and transmitting a message based on the evaluation of the first rule.

Various exemplary embodiments relate to a Diameter Routing Agent (DRA) for processing a Diameter message, the DRA including one or more of the following: a rule storage configured to store a plurality of sets of rules; a Diameter stack configured to receive a first Diameter message from a first origin device; a message handler configured to: determine a first message type associated with the first Diameter message, and identify a first set of rules of a plurality of sets of rules as being associated with the first message type; and a rule engine configured to evaluate a first rule of the first set of rules, wherein the message handler is further configured to transmit a message based on the evaluation of the first rule.

Various exemplary embodiments relate to a non-transitory machine-readable storage medium encoded with instructions for execution by a Diameter Routing Agent (DRA) for processing a Diameter message, the medium including one or more of the following: instructions for receiving a first Diameter message at the DRA from a first origin device; instructions for determining a first message type associated with the first Diameter message; instructions for identifying a first set of rules of a plurality of sets of rules as being associated with the first message type; instructions for evaluating a first rule of the first set of rules; and instructions for transmitting a message based on the evaluation of the first rule.

Various embodiments are described wherein the message type is based on an application type and a command type of the first Diameter message.

Various embodiments additionally include a second set of rules of the plurality of sets of rules as being applicable to at least two different message types; and evaluating a second rule of the second set of rules, wherein the transmitting a first message based on the evaluation of the first rule includes transmitting a first message based on the evaluation of the first rule and the evaluation of the second rule.

Various embodiments are described wherein the evaluating the second rule is performed before the evaluating the first rule.

Various embodiments additionally include receiving a second Diameter message at the DRA from a second origin device, wherein the second Diameter message is a Diameter request; evaluating a third rule of the second set of rules, wherein evaluating the third rule generates at least part of a Diameter answer; and transmitting the Diameter answer to the second origin device, wherein the transmitting is performed after only the second set of rules has been evaluated.

Various embodiments are described wherein the evaluating the first rule includes modifying the first Diameter message, and the transmitting the message based on the evaluation of the first rule includes transmitting the first Diameter message to another device.

Various embodiments are described wherein the first Diameter message is a Diameter request, the evaluating the first rule includes modifying a Diameter answer, and the transmitting the message based on the evaluation of the first rule includes transmitting the Diameter answer to the first origin device.

### BRIEF DESCRIPTION OF THE DRAWINGS

In order to better understand various exemplary embodiments, reference is made to the accompanying drawings, wherein:

FIG. 1 illustrates an exemplary network environment for a Diameter Routing Agent;

FIG. 2 illustrates an exemplary Diameter Routing Agent;

FIG. 3 illustrates an exemplary method for processing Diameter messages;

FIG. 4 illustrates an exemplary method for evaluating multiple rule sets;

FIG. 5 illustrates an exemplary general rule set;

FIG. 6 illustrates an exemplary message type-specific rule set; and

FIG. 7 illustrates an exemplary message exchange.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated.

Diameter Routing Agents (DRAs) available today provide only basic functionalities typically defined in hard coding or scripting. As such, users may typically not be empowered to easily and flexibly define more complex behaviors for a DRA. In view of the foregoing, it would be desirable to provide a method and system that facilitates user definition and extension of DRA message processing behavior.

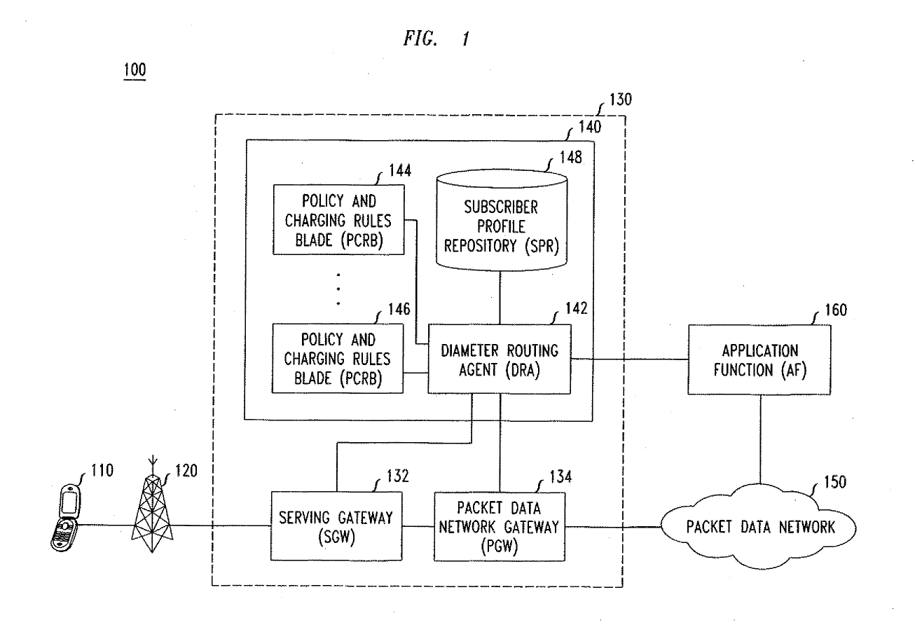

FIG. 1 illustrates an exemplary network environment 100 for a Diameter Routing Agent (DRA) 142. Exemplary network environment 100 may be a subscriber network for providing various services. In various embodiments, subscriber network 100 may be a public land mobile network (PLMN). Exemplary subscriber network 100 may be telecommunications network or other network for providing access to various services. Exemplary subscriber network 100 may include user equipment 110, base station 120, evolved packet core (EPC) 130, packet data network 150, and application function (AF) 160.

User equipment 110 may be a device that communicates with packet data network 150 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by the relevant 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the relevant 3GPP standards. EPC 130 may include a serving gateway (SGW) 132, a packet data network gateway (PGW) 134, and a session control device 140.

Serving gateway (SGW) 132 may be a device that provides gateway access to the EPC 130. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Session control device 140 may be a device that provides various management or other functions within the EPC 130. For example, session control device 140 may provide a Policy and Charging Rules Function (PCRF). In various embodiments, session control device 140 may include an Alcatel Lucent 5780 Dynamic Services Controller (DSC). Session control device 140 may include a DRA 142, a plurality of policy and charging rules blades (PCRBs) 144, 146, and a subscriber profile repository.

As will be described in greater detail below, DRA 142 may be an intelligent Diameter Routing Agent. As such, DRA 142 may receive, process, and transmit various Diameter messages. DRA 142 may include a number of user-defined rules that govern the behavior of DRA 142 with regard to the various Diameter messages DRA 142 may encounter. Based on such rules, the DRA 142 may operate as a relay agent, proxy agent, or redirect agent. For example, DRA 142 may relay received messages to an appropriate recipient device. Such routing may be performed with respect to incoming and outgoing messages, as well as messages that are internal to the session control device.

Policy and charging rules blades (PCRB) 144, 146 may each be a device or group of devices that receives requests for application services, generates PCC rules, and provides PCC rules to the PGW 134 or other PCENs (not shown). PCRBs 144, 146 may be in communication with AF 160 via an Rx interface. As described in further detail below with respect to AF 160, PCRB 144, 146 may receive an application request in the form of an Authentication and Authorization Request (AAR) from AF 160. Upon receipt of an AAR, PCRB 144, 146 may generate at least one new PCC rule for fulfilling the application request.

PCRB 144, 146 may also be in communication with SGW 132 and PGW 134 via a Gxx and a Gx interface, respectively. PCRB 144, 146 may receive an application request in the form of a credit control request (CCR) from SGW 132 or PGW 134. As with an AAR, upon receipt of a CCR, PCRB 144, 146 may generate at least one new PCC rule for fulfilling the application request. In various embodiments, the AAR and the CCR may represent two independent application requests to be processed separately, while in other embodiments, the AAR and the CCR may carry information regarding a single application request and PCRB 144, 146 may create at least one PCC rule based on the combination of the AAR and the CCR. In various embodiments, PCRB 144, 146 may be capable of handling both single-message and paired-message application requests.

Upon creating a new PCC rule or upon request by the PGW 134, PCRB 144, 146 may provide a PCC rule to PGW 134 via the Gx interface. In various embodiments, such as those implementing the proxy mobile IP (PMIP) standard for example, PCRB 144, 146 may also generate QoS rules. Upon creating a new QoS rule or upon request by the SGW 132, PCRB 144, 146 may provide a QoS rule to SGW 132 via the Gxx interface.

Subscriber profile repository (SPR) 148 may be a device that stores information related to subscribers to the subscriber network 100. Thus, SPR 148 may include a machine-readable storage medium such as read-only memory (ROM), random-access memory (RAM), magnetic disk storage media, optical storage media, flash-memory devices, and/or similar storage media. SPR 148 may be a component of one of PCRB 144, 146 or may constitute an independent node within EPC 130 or session control device 140. Data stored by SPR 138 may include subscriber information such as identifiers for each subscriber, bandwidth limits, charging parameters, and subscriber priority.

Packet data network 150 may be any network for providing data communications between user equipment 110 and other devices connected to packet data network 150, such as AF 160. Packet data network 150 may further provide, for example, phone or Internet service to various user devices in communication with packet data network 150.

Application function (AF) 160 may be a device that provides a known application service to user equipment 110. Thus, AF 160 may be a server or other device that provides, for example, a video streaming or voice communication service to user equipment 110. AF 160 may further be in communication with the PCRB 144, 146 of the EPC 130 via an Rx interface. When AF 160 is to begin providing known application service to user equipment 110, AF 160 may generate an application request message, such as an authentication and authorization request (AAR) according to the Diameter protocol, to notify the PCRB 144, 146 that resources should be allocated for the application service. This application request message may include information such as an identification of the subscriber using the application service, an IP address of the subscriber, an APN for an associated IP-CAN session, or an identification of the particular service data flows that must be established in order to provide the requested service.

As will be understood, various Diameter applications may be established within subscriber network 100 and supported by DRA 142. For example, an Rx application may be established between AF 160 and each of PCRBs 144, 146. As another example, an Sp application may be established between SPR 148 and each of PCRBs 144, 146. As yet another example, an S9 application may be established between one or more of PCRBs 144, 146 and a remote device implementing another PCRF (not shown). As will be understood, numerous other Diameter applications may be established within subscriber network 100.

In supporting the various potential Diameter applications, DRA 142 may receive Diameter messages, process the messages, and perform actions based on the processing. For example, DRA 142 may receive a Gx CCR from PGW 134, identify an appropriate PCRB 144, 146 to process the Gx CCR, and forward the Gx CCR to the identified PCRB 144, 146. DRA 142 may also act as a proxy by modifying the subsequent Gx CCA sent by the PCRB 144, 146 to carry an origin-host identification pointing to the DRA 142 instead of the PCRB 144, 146. Additionally or alternatively, DRA 142 may act as a redirect agent or otherwise respond directly to a request message by forming an appropriate answer message and transmitting the answer message to an appropriate requesting device.

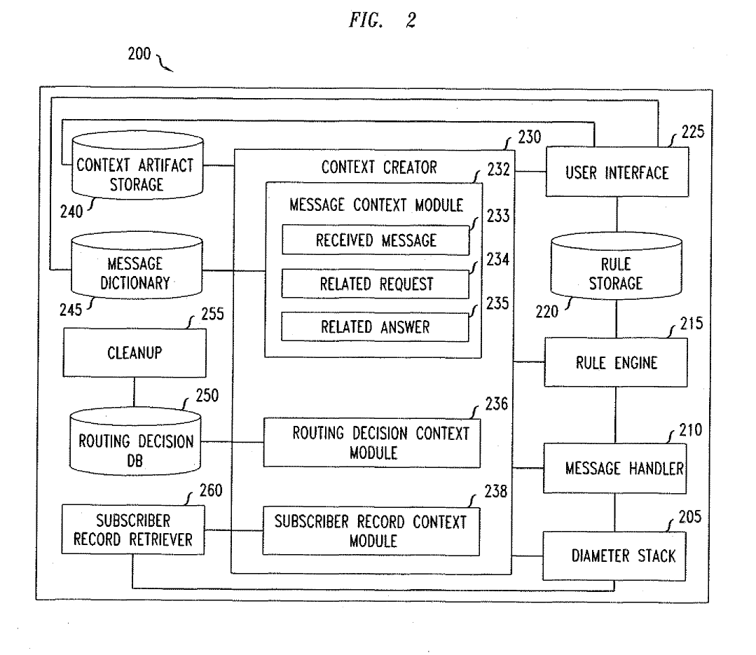

FIG. 2 illustrates an exemplary Diameter Routing Agent (DRA) 200. DRA 200 may be a standalone device or a component of another system. For example, DRA 200 may correspond to DRA 142 of exemplary environment 100. In such an embodiment, DRA 142 may support various Diameter applications defined by the 3GPP such as Gx, Gxx, Rx, or Sp. It will be understood that DRA 200 may be deployed in various alternative embodiments wherein additional or alternative applications are supported. As such, it will be apparent that the methods and systems described herein may be generally applicable to supporting any Diameter applications.

DRA 200 may include a number of components such as Diameter stack 205, message handler 210, rule engine 215, rule storage 220, user interface 225, context creator 230, context artifact storage 240, message dictionary 245, routing decision database 250, cleanup module 255, or subscriber record retriever 260.

Diameter stack 205 may include hardware or executable instructions on a machine-readable storage medium configured to exchange messages with other devices according to the Diameter protocol. Diameter stack 205 may include an interface including hardware or executable instructions encoded on a machine-readable storage medium configured to communicate with other devices. For example, Diameter stack 205 may include an Ethernet or TCP/IP interface. In various embodiments, Diameter stack 205 may include multiple physical ports.

Diameter stack 205 may also be configured to read and construct messages according to the Diameter protocol. For example, Diameter stack may be configured to read and construct CCR, CCA, AAR, AAA, RAR, and RAA messages. Diameter stack 205 may provide an application programmer's interface (API) such that other components of DRA 200 may invoke functionality of Diameter stack. For example, rule engine 215 may be able to utilize the API to read an attribute-value pair (AVP) from a received CCR or to modify an AVP of a new CCA. Various additional functionalities will be apparent from on the following description.

Message handler 210 may include hardware or executable instructions on a machine-readable storage medium configured to interpret received messages and invoke rule engine 215 as appropriate. In various embodiments, message handler 210 may extract a message type from a message received by Diameter stack 205 and invoke the rule engine using a rule set that is appropriate for the extracted message type. For example, the message type may be defined by the application and command of the received message. After the rule engine 215 finishes evaluating one or more rules, message handler 210 may transmit one or more messages via Diameter stack based upon one or more context object actions invoked by the rule engine 215.

Rule engine 215 may include hardware or executable instructions on a machine-readable storage medium configured to process a received message by evaluating one or more rules stored in rule storage 220. As such, rule engine 215 may be a type of processing engine. Rule engine 215 may retrieve one or more rules, evaluate criteria of the rules to determine whether the rules are applicable, and specify one or more result of any applicable rules. For example, rule engine 215 may determine that a rule is applicable when a received Gx CCR includes a destination-host AVP identifying DRA 200. The rule may specify that the destination-host AVP should be changed to identify a PCRB before the message is forwarded.

Rule storage 220 may be any machine-readable medium capable of storing one or more rules for evaluation by rule engine 215. Accordingly, rule storage 220 may include a machine-readable storage medium such as read-only memory (ROM), random-access memory (RAM), magnetic disk storage media, optical storage media, flash-memory devices, and/or similar storage media. In various embodiments, rule storage 220 may store one or more rule sets as a binary decision tree data structure. Various other data structure for storing a rule set will be apparent.

It will be understood that, while various components are described as being configured to perform functions such as evaluating rules or accessing context objects based on rules, such configurations may not require any rules to be present in rule storage. For example, rule engine 215 may be configured to evaluate a rule including a context object reference even if no such rule is stored in rule storage 220. Thereafter, if a user adds such a rule to rule storage, rule engine 215 may process the rule as described herein. In other words, as used herein, the phrase “configured to” when used with respect to functionality related to rules will be understood to mean that the component is capable of performing the functionality as appropriate, regardless of whether a rule that requests such functionality is actually present.

User interface 225 may include hardware or executable instructions on a machine-readable storage medium configured to enable communication with a user. As such, user interface 225 may include a network interface (such as a network interface included in Diameter stack 205), a monitor, a keyboard, a mouse, or a touch-sensitive display, User interface 225 may also provide a graphical user interface (GUI) for facilitating user interaction. User interface 225 may enable a user to customize the behavior of DRA 200. For example, user interface 225 may enable a user to define rules for storage in rule storage 220 and evaluation by rule engine 215. Various additional methods for a user to customize the behavior of DRA 200 via user interface 225 will be apparent to those of skill in the art.

According to various embodiments, rule storage 220 may include rules that reference one or more “contexts” or “context objects.” In such embodiments, context creator 230 may include hardware or executable instructions on a machine-readable storage medium configured to instantiate context objects and provide context object metadata to requesting components. Context objects may be instantiated at run time by context creator 230 and may include attributes or actions useful for supporting the rule engine 215 and enabling the user to define complex rules via user interface 225. For example, context creator 230 may provide context objects representing various Diameter messages, previous routing decisions, or subscriber profiles.

Upon DRA 200 receiving a Diameter message to be processed, message handler 210 may send an indication to context creator 230 that the appropriate context objects are to be instantiated. Context creator 230 may then instantiate such context objects. In some embodiments, context creator 230 may instantiate all known context objects or may only instantiate those context objects actually used by the rule set to be applied by rule storage 220. In other embodiments, context creator 230 may not instantiate a context object until it is actually requested by the rule engine 215.

Context creator 230 may additionally facilitate rule creation by providing context metadata to user interface 225. In various embodiments, context creator 230 may indicate to user interface 225 which context objects may be available for a rule set being modified and what attributes or actions each context object may possess. Using this information, user interface 225 may present a point-and-click interface for creating complex rules. For example, user interface 225 may enable the user to select a desired attribute or action of a context object from a list for inclusion in a rule under construction or modification.

Context creator 230 may rely on one or more context artifacts stored in context artifact storage 240 in establishing context objects. As such, context artifact storage 240 may be any machine-readable medium capable of storing one or more context artifacts. Accordingly, context artifact storage 240 may include a machine-readable storage medium such as read-only memory (ROM), random-access memory (RAM), magnetic disk storage media, optical storage media, flash-memory devices, and/or similar storage media. Context artifact storage 240 may store artifacts in various forms such as, for example, run-time libraries. In various embodiments, such run-time libraries may be stored as Java archive (.jar) files.

Each context artifact may define the attributes or actions available for a context object. In various embodiments, the context artifact may define one or more functions to be executed when an attribute or action is accessed. Such functions may utilize other functionality of the DRA 200, such as accessing the API of the Diameter stack, or may return values to the component that called the attribute or action. The context artifact may also include tags or other metadata for context creator 230 to provide to user interface 225 for describing the actions and attributes of the context object. In exemplary DRA 200, context artifact storage 240 may store context artifacts defining a message context, a routing decision context, or a subscriber record context. These context artifacts may be used by context creator 230 at run-time to instantiate different types of context objects. As such, context creator 230 may be viewed as including a message context module 232, a routing decision context module 236, and a subscriber record context module 238. In various embodiments, a user may be able to define new context artifacts via user interface 225 for storage in context artifact storage, such as by specifying an existing file (e.g. a .jar file) or by defining a new context artifact using a text editor of the user interface 225.

Message context module 232 may represent the ability of context creator 230 to generate context objects representing and providing access to Diameter messages. For example, message context module 232 may generate a context object representing the received message. In various embodiments, message context module 232 may also be configured to generate a context object representing a request message or an answer message associated with the received Diameter message, as appropriate. As such, message context module 232 may be viewed as including a received message submodule 233, a related request submodule 234, and a related answer submodule 235.

The contents of Diameter messages may vary depending on the application and command type. For example, an RX RAA message may include different data from a GX CCR message. Such differences may be defined by various standards governing the relevant Diameter applications. Further, some vendors may include proprietary or otherwise non-standard definitions of various messages. Message context module 232 may rely on message definitions stored in message dictionary 245 to generate message contexts for different types of Diameter messages. For example, upon receiving a Diameter message, message handler 210 may pass the application and command type to the context creator 230. Message context module 232 may then locate a matching definition in message dictionary 245. This definition may indicate the AVPs that may be present in a message of the specified type. Message context module 232 may then instantiate a message context object having attributes and actions that match the AVPs identified in the message definition.

Message dictionary 245 may be any machine-readable medium capable of storing one or more context artifacts. Accordingly, message dictionary 245 may include a machine-readable storage medium such as read-only memory (ROM), random-access memory (RAM), magnetic disk storage media, optical storage media, flash-memory devices, and/or similar storage media. Message dictionary 245 may include various message definitions in appropriate forms such as, for example, XML files. Message dictionary 245 may include a number of predefined definitions included with the DRA 200 by a supplier. In various embodiments, a user may be able to provide new, user-defined message definitions via user interface 225. For example, if the user wishes to support an application not already defined by the predefined definitions, the user may generate or otherwise obtain a definition file for storage in message dictionary 245. In various embodiments, the user-defined definitions may be stored in a different portion of message dictionary 245, such as a different directory, from the predefined definitions.

In various embodiments, the user may also be able to extend predefined definitions via user interface 225. The user may be able to provide extension definitions that define new AVPs or specify additional AVPs to occur in a particular message type. For example, a user may wish to support a proprietary AVP within an Rx AAR. To provide such support, the user may provide a definition file, such as an XML file, defining the proprietary AVP and indicating that the proprietary AVP may be present in an Rx AAR. Such extension definitions may also be stored in a different area of message dictionary 245 from the predefined definitions. Message context module 232 may be configured to apply any applicable extension definitions when instantiating a new message context object or providing context metadata to user interface 225.

As noted above, upon receiving a Diameter message, message handler 210 may extract the application and command type and pass this information to context creator 230, which then may locate any applicable definitions to instantiate a new received message context object. Received message submodule 233 may be further configured to associate the new context object with the received Diameter message itself. For example, received message submodule 233 may copy the received Diameter message from Diameter stack 205 into a private or protected variable. Alternatively, received message submodule 233 may store an identification of the Diameter message useful in enabling access to the Diameter message via the API of the Diameter stack 205.

In various embodiments, DRA 200 may support the use of inverse message contexts. In such embodiments, upon extracting the command type from the received Diameter message, message handler 210 may identify the inverse command type as well. In some such embodiments, message handler 210 may implement a look-up table identifying the inverse for each message command. For example, upon determining that a received Diameter message is a Gx CCR, the message handler may determine that the inverse message would be a Gx CCA. Message handler 210 may pass this information to context creator 230 as well.

Upon receiving an inverse message type, message context module 232 may instantiate an inverse message context object in a manner similar to that described above with regard to the received message context object. Related request submodule 234 or related answer submodule 235, as appropriate, may also associate the new context object with message data. If the inverse message is a request message, related request module 234 may identify a previously-processed request message stored in Diameter stack 205 and associate the message with the new context object in a manner similar to that described above. In various embodiments, upon receiving an answer message, Diameter stack 205 may locate the previously-processed and forwarded request message to which the answer message corresponds. Diameter stack 205 may present this related request message through the API for use by context creator 230 or other components of DRA 200. By associating the previous request message with the related request context object, rule engine 215 may be provided with attributes capable of accessing the AVPs carried by the request message that prompted transmission of the answer message being processed.

When the inverse message is an answer message, on the other hand, related answer module 235 may construct a new answer message by, for example, requesting, via the API, that Diameter stack 205 construct the answer message. The new answer message may be completely blank or may include at least some values copied over from the received Diameter request message. Related answer module 235 may associate the new context object with the new answer message in a manner similar to that described above with respect to received message module 233. The related answer context object may then provide rule engine 215 with access to various actions capable of modifying the new answer message. For example, the rule engine may utilize an action of the related answer context object to set a result-code AVP of the answer message, thereby indicating to the message handler 210 that the answer should be sent back to the device that sent the received request. Message handler 210 may also then refrain from forwarding the received request message to any other devices.

As noted above, context creator 230 may be capable of defining other context objects that do not represent a Diameter message. Such context objects may be referred to as “computational contexts” and may also be defined by contexts artifacts in context artifact storage 240. As an example, routing decision context module 236 may be configured to instantiate a routing decision context object. Such routing decision context may identify, for each received Diameter message, a previously made routing decision that may be applicable to the received message. Such previously made routing decisions may be stored in routing decision database 250 along with a session identifier for correlating received messages to previously-processed messages. Routing decision database 250 may be any machine-readable medium capable of storing such routing decisions. Accordingly, routing decision database 250 may include a machine-readable storage medium such as read-only memory (ROM), random-access memory (RAM), magnetic disk storage media, optical storage media, flash-memory devices, and/or similar storage media.

Computational contexts may be supported by other DPA 200 functionality. For example, DPA 200 may include a cleanup module 255 that periodically removes stale entries from routing decision database 250. In some embodiments, the routing decision context object may not interact directly with cleanup module 255. Instead, cleanup module 255 may operate independently, while affecting the behavior of the routing decision context object indirectly by modifying the contents of routing decision database 250.

As another example of a computational context, subscriber record context module 238 may generate a subscriber record context object. The subscriber record context object may utilize other DRA 200 functionality, such as subscriber record retriever 260, to retrieve a subscriber record for received Diameter messages. Subscriber record retriever 260 may include hardware or executable instructions on a machine-readable storage medium configured to communicate with a subscriber profile repository (SPR) via Diameter stack 205 to retrieve a subscriber record for a Diameter message. Such communication may be performed, for example, according to the Sp application. Various methods of implementing subscriber record retriever 260 will be apparent. Through this retrieval of a subscriber record, the subscriber record context object may provide the rule engine 215 with access to the subscriber record

It should be noted that while rule storage 220, context artifact storage 240, message dictionary 245, and routing decision database 250 are illustrated as separate devices, one or more of these components may be resident on multiple storage devices. Further, one or more of these components may share a storage device. For example, rule storage, context artifact storage 240, message dictionary 245, and routing decision database 250 may all refer to portions of the same hard disk or flash memory device.

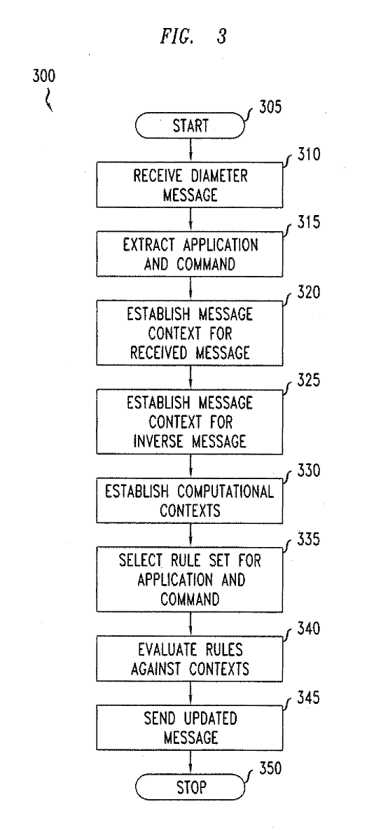

FIG. 3 illustrates an exemplary method 300 for processing Diameter messages. Method 300 may be performed by the components of DRA 200 such as, for example, Diameter stack 205, message handler 210, rule engine 215, or context creator 230.

Method 300 may begin in step 305 and proceed to step 310 where the DRA 200 may receive a Diameter message to be processed. Next, in step 315, the DRA 200 may extract a message type from the received Diameter message. In various embodiments, the message type may be defined by the application and command type of the message. Then, in step 320, the DRA may use the extracted message type to establish a message context object to wrap the received Diameter message. In a similar manner, the DRA 200 may establish a message context object for an inverse of the Diameter message in step 325. For example, the DRA 200 may use a lookup table to identify the inverse message type of the extracted message type and request a new message context based on the inverse message type.

The DRA 200 may then, in step 330, proceed to establish any other computational context objects for which the DRA 200 stores a context artifact or which the rule engine may request. For example, the DRA 200 may establish a routing decision context object and a subscriber record context object. After the appropriate context objects have been at least instantiated, method 300 may proceed to step 335 where the DRA 200 may select one or more appropriate rule sets to evaluate in processing the received Diameter message. In various embodiments, the DRA 200 may store one rule set for each message type. In some embodiments, DRA 200 may additionally or alternatively store a rule set that is generally applicable to all Diameter messages, all Diameter messages of a particular application, or another subset of Diameter messages.

After identifying the appropriate rule sets, the DRA 200 may evaluate the selected rule set or tables against the instantiated contexts in step 340. The individual rules may include references to various components of the context objects, herein referred to as “context object references.” Such components may constitute attributes or actions of the context objects. To evaluate a rule including such a reference, the DRA may access the referenced component. For example, an attribute of a context object may be used in a comparison to determine whether a rule is applicable or an action of a context object may be used in applying the result of a rule. Various additional uses for a reference to a context object will be apparent. After applying the appropriate rule sets, the DRA 200 may transmit one or more messages to other devices in step 345. For example, the DRA may forward the Diameter message, which may be modified, to another device or may transmit an answer back to the device that sent the received message. Method 300 may proceed to end in step 350.

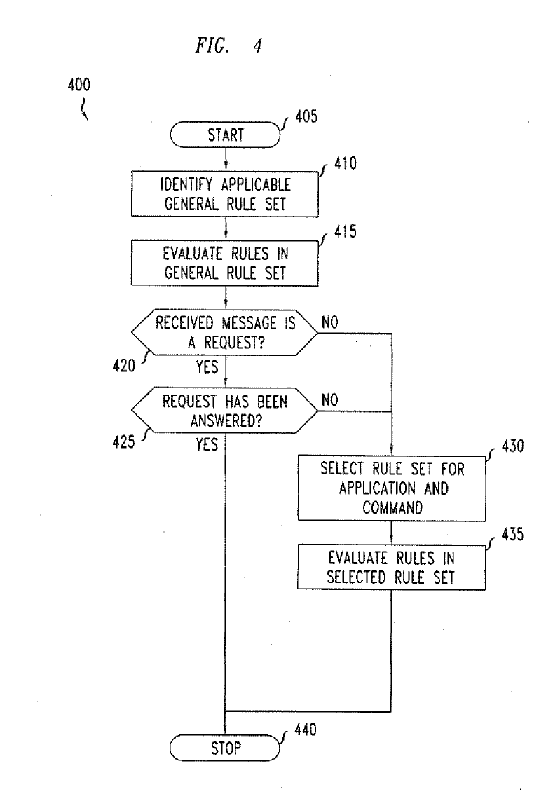

As noted above, steps 335 and 340 may involve the evaluation of different types of rule sets. For example, in some embodiments, each message type may be associated with a rule set which applies to message of that type. Thus, one rule set may be applied for Gx CCR messages while a different rule set may be applied for Rx AAR messages. Some embodiments may also include rule sets that are generally applicable to all Diameter messages, all Diameter requests, or all Diameter answers. In such embodiments, the DRA 200 may evaluate multiple rule sets in sequence. FIG. 4 illustrates an exemplary method 400 for evaluating multiple rule sets. Method 400 may be performed by the components of DSC 200 in place of steps 335, 340 of method 300.

Method 400 may begin in step 405 and proceed to step 410 where the DRA 200 may identify a general rule set that is applicable to the message received in step 310. For example, the DRA 200 may include a rule set that is generally applicable to all messages, all Diameter messages, all Diameter requests, or all Diameter answers. For example, if the received message is a GX CCR, the DRA 200 may identify the general rule set for all Diameter requests. Then, in step 415, the DRA 415 may evaluate the identified rule set. In doing so, the DRA 200 may modify the received message or generate a different Diameter message to be sent back to the origin device.

After evaluating the general rule set, method 400 may proceed to step 420 where the DRA 200 may determine whether the received message was a request message. If the message was a request message, method 400 may proceed to step 425 where the DRA 200 may determine whether the request has been answered. For example, during step 415, the DRA 200 may generate or modify a Diameter answer message. In step 425, the DRA 200 may determine whether a result-code AVP or experimental-result AVP of the Diameter answer has been set to determine whether an answer message has been constructed for transmission to the origin device. If so, method 400 may proceed to end in step 440 without evaluating any additional rules. The DRA 200 may proceed to transmit the answer message back to the origin device, for example, in step 345 of step 300.

If, on the other hand, the received message is not a request message or has not been answered in step 415, method 400 may proceed to step 430. In step 430, the DRA 200 may select a second rule set that is applicable to the received message. For example, the DRA 200 may locate a rule set associated with the application and command type of the received message. For example, if the received Diameter message is a Gx CCR, the DRA 200 may identify a rule set associated with Gx CCR messages. Then, in step 435, the DRA 200 may invoke the rule engine a second time. This invocation may involve passing the rule set identified in step 430 to the rule engine, instead of the rule set identified in step 410. Thus, the DRA 200 may evaluate the rule set specifically associated with the message type of the received Diameter message in step 435. Method 400 may proceed to end in step 440. In various embodiments, the DRA 200 may proceed to step 345 of method 300 after completing method 400.

Various modifications will be apparent for method 400. For example, in some embodiments, more than two rule sets may be applicable to a received Diameter message. In such embodiments, method 400 may invoke the rules engine more than twice. As another example, various embodiments may evaluate all applicable rule sets before determining whether a request has been answered, or may not determine whether a request has been answered at all.

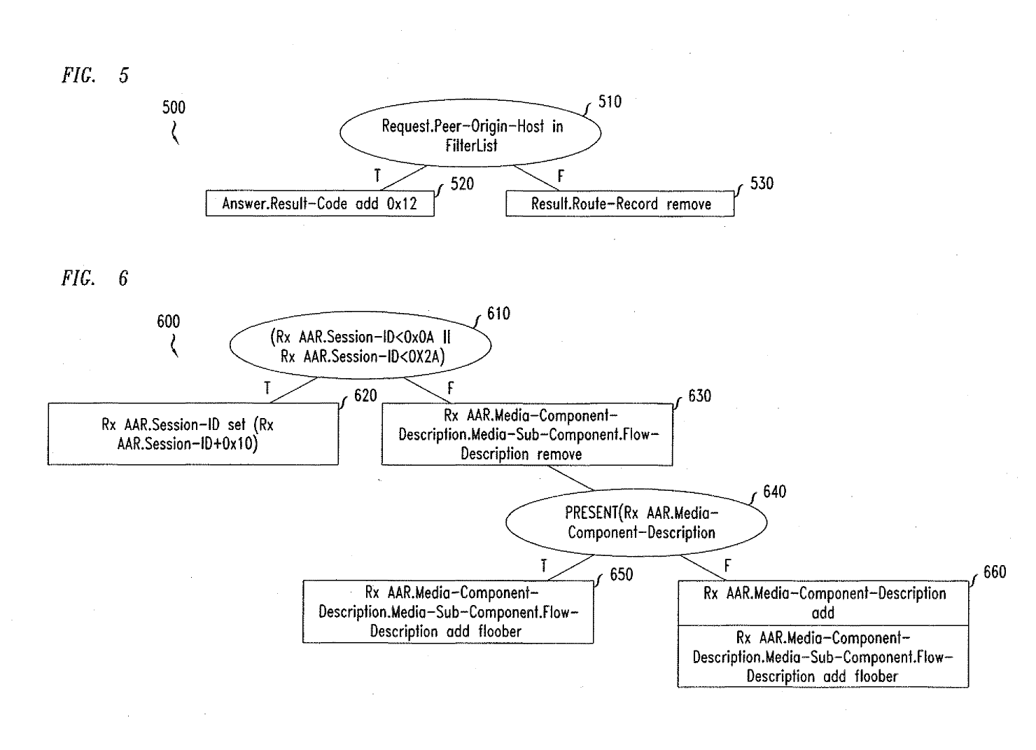

FIG. 5 illustrates an exemplary general rule set 500. General rule set 500 may be stored in a rule storage such as rule storage 220 of DRA 200. In various embodiments, general rule set 500 may be stored as a binary decision tree, as illustrated. It will be apparent that various alternative arrangements may be used for storing a rule set. For example, rule set 500 may be stored as a plurality of records that each include a criteria field for evaluation to determine whether a rule is applicable and a result field storing an action or set of actions to be taken when the rule is applicable. Further, general rule set 500 may be stored as, for example, a table in a database stored in rule storage 220. Alternatively, rule set 500 could be a series of linked lists, an array, or a similar data structure. Thus, it should be apparent that rule set 500 may be an abstraction of the underlying data; any data structure suitable for storage of this data may be used.

General rule set 500 may be generally applicable to all Diameter requests. A DRA may store a separate general rule set (not shown) that is applicable to all Diameter answers. Rule set 500 may include criteria nodes such as criteria node 510 and result nodes such as result nodes 520, 530. It will be apparent that rule set 500 is exemplary and that various embodiments may include rule sets (not shown) that are more complex than the rule set 500 as illustrated.

Criteria nodes may present a condition to be evaluated by a rule engine. Based on the evaluation, the rule engine may select another criteria node or a result node to evaluate. As an example, criteria node 510 may store the condition “Request.Peer-Origin-Host in FilterList.” Upon evaluation of criteria node 510, a rule engine may determine whether the condition is true or false. For example, the rule engine may read a “Peer-Origin-Host” attribute from a “Request” context object that represents the received message or some other request message, and determine whether the value is listed in a separately defined “FilterList” that may list peer-origin-hosts for which messages should be blocked. If it is, the rule engine may select result node 520 as the next node to evaluate. If the value is not listed in the “FilterList,” the rule engine may select result node 530 as the next node to be evaluated.

Result nodes may present one or more actions to be performed by a rule engine. Such actions may include, for example, modifying a Diameter message or transmitting a Diameter message to a particular device. As an example, result node 520 may indicate that the rule engine should add a “Result-Code” AVP having the value “0x12” to an “Answer” context object. This “Answer” context abject may represent a related answer message created in a Diameter stack, as discussed above with respect to the related answer module 235 of DRA 200. As another example, result node 530 may indicate that the rule engine should access a “remove” action of the “Request” context object to remove a Route-Record AVP from the Diameter message, thereby hiding the route record from subsequent devices to receive the Diameter message. The rule engine may be finished evaluating rule set 500 after encountering result node 520 or result node 530 because these nodes may also be leaf nodes having no other children nodes.

It will be apparent that rule set 500 may take on various alternative structures. For example, rule set 500 may include fewer or additional criteria nodes or result nodes. Further, a criteria node may include another criteria node as a child or a result node may include another result node as a child.

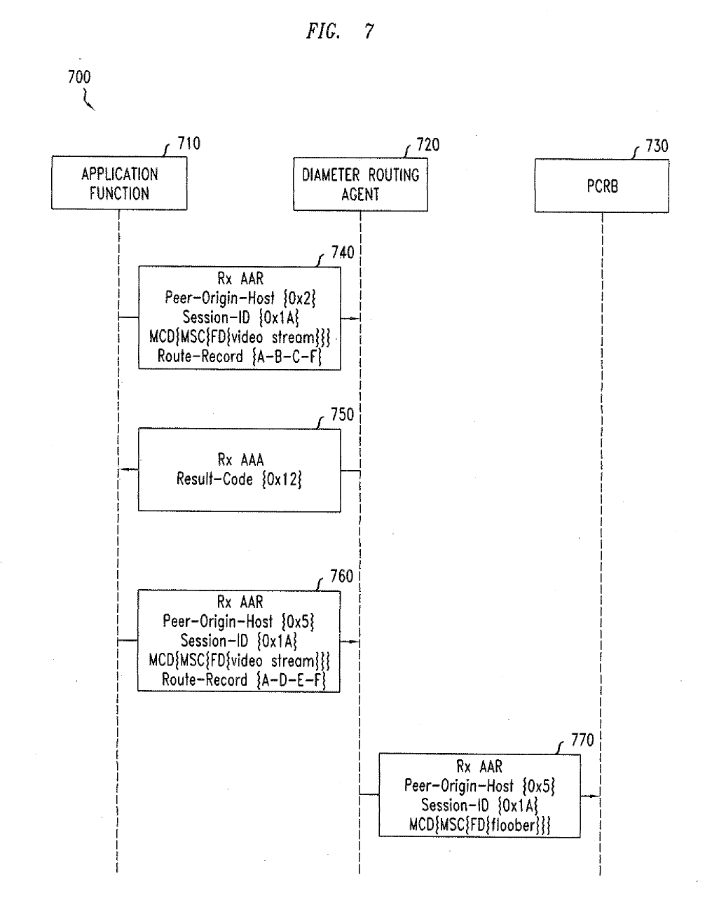

FIG. 6 illustrates an exemplary message type-specific rule set 600. Rule set 600 may be stored in a rule storage such as rule storage 220 of DRA 200. In various embodiments, rule set 600 may be stored as a binary decision tree, as illustrated. It will be apparent that various alternative arrangements may be used for storing a rule set. For example, rule set 600 may be stored as a plurality of records that each include a criteria field for evaluation to determine whether a rule is applicable and a result field storing an action to be taken when the rule is applicable. Further, rule set 600 may be stored as, for example, a table in a database stored in rule storage 220. Alternatively, rule set 600 could be a series of linked lists, an array, or a similar data structure. Thus, it should be apparent that rule set 600 may be an abstraction of the underlying data; any data structure suitable for storage of this data may be used.

Message type-specific rule set 600 may be applicable to Diameter messages of a particular message type such as, for example, Rx AAR messages. A DRA may store separate message type-specific rule sets (not shown) for a number of different message types. Similar to rule set 500, rule set 600 may include criteria nodes such as criteria nodes 610, 640 and result nodes such as result nodes 620, 630, 650, 660.

As an example, criteria node 610 may store the condition “(Rx AAR.Session-ID<0x0A∥Rx AAR.Session-ID>0x2A)” which may evaluate to “true” when the Session-ID of the “Rx AAR” context object is less than 0x0A or greater than 0x2A. When criteria node 610 evaluates to “true,” a rule engine may evaluate result node 620. Such evaluation may include adding a value of 0x10 to the current value of the Session-ID AVP.

If criteria node 610 evaluates to false, the rule engine may evaluate result node 630. Such evaluation may include accessing a “remove” action for a Flow-Description AVP of the Rx AAR context object. The rule engine may then move on to criteria node 640. Criteria node 640 may include the condition “Present(Rx AAR.Media-Component-Description” which may evaluate to true when the Rx AAR object includes a Media-Component-Description AVP. When criteria node 640 evaluates to true, the rule engine may move on to result node 650 where the rule engine may set a Flow-Description AVP to a value of “floober.” If criteria node 640 evaluates to false, the rule engine may move on to result node 660. Result node 660 may specify multiple actions to be taken during evaluation. For example, result node 660 may indicate that a new Media-Component-Description should be added to the Rx AAR context object and that a Flow-Description of “floober” should be added to a Media-Sub-Component AVP.

It will be apparent the rule sets 500, 600 may be generated based on user input. In various embodiments, a user interface may enable a user to construct a tree as shown. In other embodiments, the user interface may generate binary decision trees or other rule representations based on a different rule definition provided by the user. For example, rule sets 500, 600 may be generated based on the following pseudocode rule definitions provided by a user:

RULE SETS:

Diameter Request

IF (RULE FilterRule)

(Request.Peer-Origin-Host in FilterList)

THEN

Answer.Result-Code add 0x12

ELSE

Request.Route-Record remove

RULE SETS:

Rx AAR

IF (RULE Session-IDCheck)

(Rx AAR.Session-ID < 0x0A | | Rx AAR.Session-ID > 0x2A)

THEN

Rx AAR.Session-ID set (Rx AAR.Session-ID + 0x10)

ELSE

Rx AAR.Media-Component-Description.Media-Sub-Component.Flow-

Description remove

IF (RULE FlooberRule)

Present(Rx AAR.Media-Component-Description)

THEN

Rx AAR.Media-Component-Description.Media-Sub-Component.Flow-

Description add floober

ELSE

Rx AAR.Media-Component-Description add
Rx AAR.Media-Component-Description.Media-Sub-Component.Flow-

Description add floober

Upon receiving the above pseudocode, a DRA may generate a rule set in a form that may be more quickly or efficiently evaluated during runtime. Various alternative methods for enabling a user to define rules or a rule set will be apparent.

Having described exemplary components and methods for operation of exemplary network 100 and DRA 200, an example of the operation of a DRA will now be provided with reference to FIGS. 1-7. FIG. 7 illustrates an exemplary message exchange 700. Message exchange 700 may occur between an application function 710, DRA 720, and a PCRB 730. For the purposes of example, application function 710 may correspond to application function 160; DRA 720 may correspond to DRA 142 and DRA 200; PCRB may correspond to PCRB 144; Methods 300, 400 may describe the operation of DRA 720, and rule sets 500, 600 may describe the contents of rule storage 220.

The process may begin in step 310 where DRA 720 may receive Diameter message 740 from AF 710. The message handler 210 may extract the application and command “Rx AAR” from message 740 in step 315 and proceed to establish any context objects in steps 320-330. For example, context creator 230 may instantiate an Rx AAR context object and an Rx AAA context object.

In step 410, the message handler may determine that general rule set 500 may be applicable to message 740 because message 740 is a Diameter request. Message handler 210 may then invoke rule engine 215 with rule set 500 in step 415. As part of step 415, the rule engine 215 may evaluate criteria node 510 and determine that the Peer-Origin-Host associated with Rx AAR 740, “0x2” may belong to the FilterList. Consequently, rule engine 215 may evaluate result node 520 and add a ResultCode AVP with value “0x12” to the Rx AAA context object. DRA 720 may then determine steps 420, 425 that the received message was a request message and that the request has been answered in step 415 because the Result-Code AVP has been set in the AAA. DRA 720 may proceed to transmit message 750 back to AF 710 based on the evaluation of rule set 500 only.

Subsequently, AF 710 may transmit another Rx AAR message 760 to DRA 720. After performing steps 310-330 and 410, as described above. In evaluating rule set 500 with respect to message 760, however, the rule engine 215 may determine that the Peer-Origin-Host “0x5” is not on the FilterList. As such, the rule engine 215 may evaluate result node 530 by accessing the remove action for the Route-Record object of the Request context object.

Next, because the request may not have been answered in step 415, method 400 may proceed to step 430 from step 425 where the message handler 210 may identify rule set 600 as being applicable to Rx AAR messages such as message 760. Message handler 210 may then invoke the rule engine a second time in step 435, this time with rule set 600. Rule engine may first determine that criteria node 610 evaluates to “false” because the Session-ID 0x1A is greater than 0x0A but less than 0x2A. As such, rule engine 215 may evaluate result node 630 by removing the Flow-Description AVP from the message 760. Next, after determining that a Media-Component-Description is present in the message 760, rule engine 215 may evaluate result node 650 by adding a Flow-Description AVP having the value “floober” to the Media-Sub-Component. Finally, the DRA may transmit modified message 770 to PCRB 730 in step 345. As shown, the message 770 has been modified based on rule sets 500,600 to include the Flow-Description “floober” and to no longer include the Route-Record AVP.

According to the foregoing, various embodiments enable robust and dynamic handling of various Diameter messages at a diameter routing agent. In particular, by including rules that are generally applicable to broad categories of Diameter messages as well as rule sets that are related to specific Diameter message types, a DRA may facilitate a user in specifying complex behaviors to be followed in processing various Diameter messages. For example, a user can specify different behaviors to be applied for different Diameter applications, yet still enforce other system-wide policies in an efficient manner. Various additional benefits will be apparent from the foregoing disclosure.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a Diameter Routing Agent (DRA) for processing a Diameter message, the method comprising:
receiving a first Diameter message at the DRA from a first origin device;
determining a first message type associated with the first Diameter message;
identifying a first set of rules of a plurality of sets of rules as being associated with the first message type;
evaluating a first rule of the first set of rules; and
transmitting a message based on the evaluation of the first rule.

2. The method of claim 1, wherein the message type is based on an application type and a command type of the first Diameter message.

3. The method of claim 1, further comprising:
identifying a second set of rules of the plurality of sets of rules as being applicable to at least two different message types; and
evaluating a second rule of the second set of rules,
wherein the transmitting a first message based on the evaluation of the first rule comprises transmitting a first message based on the evaluation of the first rule and the evaluation of the second rule.

4. The method of claim 3, wherein the evaluating the second rule is performed before the evaluating the first rule.

5. The method of claim 4, further comprising:
receiving a second Diameter message at the DRA from a second origin device, wherein the second Diameter message is a Diameter request;
evaluating a third rule of the second set of rules, wherein evaluating the third rule generates at least part of a Diameter answer; and
transmitting the Diameter answer to the second origin device, wherein the transmitting is performed after only the second set of rules has been evaluated.

6. The method of claim 1, wherein:
the evaluating the first rule comprises modifying the first Diameter message, and
the transmitting the message based on the evaluation of the first rule comprises transmitting the first Diameter message to another device.

7. The method of claim 1, wherein:
the first Diameter message is a Diameter request,
the evaluating the first rule comprises modifying a Diameter answer, and
the transmitting the message based on the evaluation of the first rule comprises transmitting the Diameter answer to the first origin device.

8. A Diameter Routing Agent (DRA) for processing a Diameter message, the DRA comprising:
a rule storage configured to store a plurality of sets of rules;
a Diameter stack configured to receive a first Diameter message from a first origin device;
a message handler configured to:
determine a first message type associated with the first Diameter message, and
identify a first set of rules of a plurality of sets of rules as being associated with the first message type; and
a rule engine configured to evaluate a first rule of the first set of rules,
wherein the message handler is further configured to transmit a message based on the evaluation of the first rule.

9. The DRA of claim 8, wherein the message type is based on an application type and a command type of the first Diameter message.

10. The DRA of claim 8, wherein:
the message handler is further configured to identify a second set of rules of the plurality of sets of rules as being applicable to at least two different message types,
the rule engine is further configured to evaluate a second rule of the second set of rules, and
in transmitting a first message based on the evaluation of the first rule, the message handler is configured to transmit a first message based on the evaluation of the first rule and the evaluation of the second rule.

11. The DRA of claim 10, wherein the rule engine evaluates the second rule before evaluating the first rule.

12. The DRA of claim 11, wherein:
the Diameter stack is further configured to receive a second Diameter message from a second origin device, wherein the second Diameter message is a Diameter request,
the rule engine is further configured to evaluate a third rule of the second set of rules, wherein evaluating the third rule generates at least part of a Diameter answer, and
the message handler is further configured to transmit the Diameter answer to the second origin device, wherein the transmitting is performed after only the second set of rules has been evaluated.

13. The DRA of claim 8, wherein:
in evaluating the first rule, the rule engine is configured to modify the first Diameter message, and
in transmitting the message based on the evaluation of the first rule, the message handler is configured to transmit the first Diameter message to another device.

14. The DRA of claim 8, wherein:
the first Diameter message is a Diameter request,
in evaluating the first rule, the rule engine is configured to modify a Diameter answer, and
in transmitting the message based on the evaluation of the first rule, the message handler is configured to transmit the Diameter answer to the first origin device.

15. A non-transitory machine-readable storage medium encoded with instructions for execution by a Diameter Routing Agent (DRA) for processing a Diameter message, the medium comprising:
instructions for receiving a first Diameter message at the DRA from a first origin device;
instructions for determining a first message type associated with the first Diameter message;
instructions for identifying a first set of rules of a plurality of sets of rules as being associated with the first message type;
instructions for evaluating a first rule of the first set of rules; and
instructions for transmitting a message based on the evaluation of the first rule.

16. The non-transitory machine-readable storage medium of claim 15, further comprising:
instructions for identifying a second set of rules of the plurality of sets of rules as being applicable to at least two different message types; and
instructions for evaluating a second rule of the second set of rules,
wherein the instructions for transmitting a first message based on the evaluation of the first rule comprise instructions for transmitting a first message based on the evaluation of the first rule and the evaluation of the second rule.

17. The non-transitory machine-readable storage medium of claim 16, wherein the instructions for evaluating the second rule are executed before the instructions for evaluating the first rule.

18. The non-transitory machine-readable storage medium of claim 17, further comprising:
instructions for receiving a second Diameter message at the DRA from a second origin device, wherein the second Diameter message is a Diameter request;
instructions for evaluating a third rule of the second set of rules, wherein evaluating the third rule generates at least part of a Diameter answer; and
instructions for transmitting the Diameter answer to the second origin device, wherein the instructions for transmitting the Diameter answer are executed after only the second set of rules has been evaluated.

19. The non-transitory machine-readable storage medium of claim 15, wherein:
the instructions for evaluating the first rule comprise instructions for modifying the first Diameter message, and
the instructions for transmitting the message based on the evaluation of the first rule comprise instructions for transmitting the first Diameter message to another device.

20. The non-transitory machine-readable storage medium of claim 15, wherein:
the first Diameter message is a Diameter request,
the instructions for evaluating the first rule comprise instructions for modifying a Diameter answer, and
the instructions for transmitting the message based on the evaluation of the first rule comprise instructions for transmitting the Diameter answer to the first origin device.
